(19) United States
(12) Patent Application Publication
(10) Pub. No.: US 2005/0084595 A1
(43) Pub. Date: Apr. 21, 2005

(54) Processed cheeses comprising emulsified liquid shortening compositions comprising dietary fiber gel, water and lipid

(76) Inventors: Triveni P. Shukla, New Berlin, WI (US); Gregory J. Halpern, Vernon Hills, IL (US)

Correspondence Address: Timothy J. Fullin;Fullin Legal Services LLC, 711 North Milwaukee Avenue, Libertyville, IL, 60048, US

(21) Appl. No.: 10/689,209

(22) Filed: Oct. 20, 2003

(51) Int. Cl. A23C 19/00

(52) U.S. Cl. 426/582

(57) ABSTRACT

According to the present invention, fat and caloric content of processed cheeses can be reduced by the replacement of a portion fat content normally found in processed cheeses with an equal amount of emulsified liquid shortening composition comprising dietary fiber gel, water and lipid. The result is that fat and caloric content of processed cheeses can be manipulated with minimal effect on taste and texture. Furthermore, these emulsified mixtures, or “emulsified liquid shortening compositions comprising dietary fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of processed cheeses, further health benefits can be achieved by replacing a portion of fat with emulsified liquid shortening compositions comprising dietary fiber gel, water and lipid.

### B. CROSS-REFERENCE TO RELATED APPLICATIONS

Not Applicable.

### C. STATEMENT REGARDING FEDERALLY SPONSORED RESEARCH/DEVELOPMENT

The present invention does not involve any form of federally sponsored research or development.

### D. BACKGROUND OF THE INVENTION

The present invention relates to processed cheeses comprising emulsified liquid shortening compositions comprising dietary fiber gel, water and lipid. Recent media attention to the global problem of obesity demonstrates a need for greater availability of foods with low caloric and fat content. This is especially true for foods that typically have high fat and caloric content, such as processed cheeses.

Processed cheeses typically comprise some fat. Other ingredients can vary according to the type of processed cheese and the recipe followed, but typically, processed cheeses are high in both fat and caloric content. Examples of processed cheeses include but are not limited to processed cheese food, spreadable cheese foods and the like.

In recent years, some companies have begun to offer reduced fat processed cheeses. This variety of processed cheese, however, often fails to retain the desirable taste and texture of processed cheeses comprising higher fat contents.

The absence of a means to reduce the fat and caloric content of processed cheeses while still producing a desirably flavored and textured processed cheese presents an unmet need in today's food industry.

### E. BRIEF SUMMARY OF THE INVENTION

It is an object of the present invention to provide a unique composition of matter embodied by low-calorie and low-fat processed cheeses. This reduction in caloric and fat content answers an unmet need in the food industry to provide the consuming public with a healthier, higher fiber alternative to traditional types of processed cheeses that typically are inherently fattening. It is another object of the present invention to provide processed cheeses that have been fortified with insoluble fiber and other functional foods.

Dietary fiber gels for calorie reduced foods hold the key to meeting this need. Dietary fiber gels for calorie reduced foods are fully described in U.S. Pat. No. 5,766,662 (the '662 patent). These dietary fiber gels comprise insoluble dietary fibers consisting of morphologically disintegrated cellular structures, and are characterized by their ability to retain large amounts of water. Additionally, these dietary fiber gels are characterized by their high viscosity at low solid levels. Other insoluble fibers derived from cereals, grains and legumes consist of morphologically in tact cellular structures, and thus impart a gritty texture to the foods in which they are contained. The dietary fiber gels disclosed in the '662 patent, however, consist of morphologically disintegrated cellular structures and thus impart a smoother texture than other insoluble fiber formulations.

More specifically, the present invention utilizes emulsified mixtures of the dietary fiber gels disclosed in the '662 patent, the emulsified mixtures further comprising, at a minimum, water and lipid. These emulsified mixtures are fully described in and are the subject of U.S. patent application Ser. No. 10/669,731 filed Sep. 24, 2003. These emulsified mixtures, or “emulsified liquid shortening compositions comprising dietary fiber gel, water and lipid”, can further comprise functional foods such as high omega three and omega six oils and pure omega three and omega six fatty acids, medium chain triglyceride, beta carotene, calcium estearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources, and any combination thereof. Hence, in addition to reducing fat and caloric content of processed cheeses, further health benefits can be achieved by replacing a portion of fat with emulsified liquid shortening compositions comprising dietary fiber gel, water and lipid.

According to the present invention, fat and caloric content can be reduced by the replacement of the fat normally found in processed cheeses with emulsified liquid shortening compositions comprising dietary fiber gel, water and lipid. This replacement of fat does not adversely affect either the taste or texture of the processed cheeses. In fact, the added emulsified liquid shortening helps to increase the moisture content of the cheese while simultaneously lowering the fat content. The result is that fat and caloric content of processed cheeses can be manipulated with minimal effect on taste and texture, and as stated above, additional health benefits can be achieved through consumption of processed cheeses comprising emulsified liquid shortening compositions comprising dietary fiber gel, water and lipid when functional foods are included in the formulations.

Further objects, advantages and features of the present invention will present themselves in the following detailed description.

### F. DETAILED DESCRIPTION OF THE PREFERRED EMBODIMENT

This invention is directed to processed cheeses comprising emulsified liquid shortening compositions comprising dietary fiber gel, water and lipid. According to the present invention, fat and caloric content can be reduced by the replacement of the fat normally found in processed cheeses with emulsified liquid shortening compositions comprising dietary fiber gel, water and lipid (hereinafter “emulsified liquid shortening”). This replacement of fat does not adversely affect either the taste or texture of the processed cheeses. The result is that fat and caloric content of processed cheeses can be manipulated with minimal effect on taste and texture.

Processed cheeses can be formulated such that the processed cheese comprises 0.1 percent to 3.5 percent dietary fiber gel solids by replacing an appropriate amount, that is, an amount prorated to deliver this range of dietary fiber gel solids, of fat, including oil and liquid shortening, with an essentially identical amount of emulsified liquid shortening. The result is that fat and caloric content of processed cheeses can be manipulated with minimal effect on taste and texture, and as stated above, additional health benefits can be achieved through consumption of processed cheeses comprising emulsified liquid shortening compositions comprising dietary fiber gel, water and lipid when functional foods are included in the formulations.

1. processed cheese, the cheese having a formulation, the cheese comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.1 percent to 3.5 percent by weight of the overall processed cheese formulation, and
the emulsified liquid shortening composition comprising dietary fiber gel, water and lipid replaces an equal amount of fat used in an otherwise identical recipe of processed cheese that uses no emulsified liquid shortening compositions comprising dietary fiber gel, water and lipid, and wherein the dietary fiber gel comprises insoluble dietary fiber.

2. processed cheese spread, the processed cheese spread having a formulation, the processed cheese spread comprising emulsified liquid shortening composition comprising dietary fiber gel, water and lipid,
wherein the emulsified liquid shortening composition comprising dietary fiber gel, water and lipid is added in a prorated amount such that solids contained within the dietary fiber gel represent 0.1 percent to 3.5 percent by weight of the overall processed cheese spread formulation, and
the emulsified liquid shortening composition comprising dietary fiber gel, water and lipid replaces an equal amount of fat used in an otherwise identical recipe of processed cheese spread that uses no emulsified liquid shortening compositions comprising dietary fiber gel, water and lipid, and wherein the dietary fiber gel comprises insoluble dietary fiber.
